(19) United States
(12) Patent Application Publication
(10) Pub. No.: US 2022/0184500 A1
(43) Pub. Date: Jun. 16, 2022

(54) GAME REALIZATION METHOD, GAME REALIZATION APPARATUS AND PROGRAM

(71) Applicant: NIPPON TELEGRAPH AND TELEPHONE CORPORATION, Tokyo (JP)

(72) Inventors: Yoshinari SHIRAI, Tokyo (JP); Masafumi MATSUDA, Tokyo (JP); Yasue KISHINO, Tokyo (JP); Shin MIZUTANI, Tokyo (JP); Takayuki SUYAMA, Tokyo (JP)

(73) Assignee: NIPPON TELEGRAPH AND TELEPHONE CORPORATION, Tokyo (JP)

(21) Appl. No.: 17/438,336

(22) PCT Filed: Mar. 2, 2020
(86) PCT No.: PCT/JP2020/008743

§ 371 Date: Sep. 10, 2021

(30) Foreign Application Priority Data
Mar. 12, 2019 (JP) 2019-044930

(51) Int. Cl. A63F 13/69; A63F 13/355

(52) U.S. Cl. CPC A63F 13/69; A63F 13/355

(57) ABSTRACT

A computes executes a first transmission procedure for transmitting first information including information on a web page displayed on a web browser to an information processing device connected via a network, a first reception procedure for receiving second information on a screen of a game using the web page, the second information being generated on the basis of the first information by the information processing device, a display procedure for displaying the screen on the basis of the second information, and a control procedure for controlling a process according to an operation of a user with respect to the web page after the screen is displayed, thereby efficiently realizing a game on any web page.

### TECHNICAL FIELD

The present invention relates to a game realization method, a game realization device, and a program.

### BACKGROUND ART

Many location information games (location-based games) obtained by converting the real world into a game on the basis of location information have already been released, and among them, Pokémon GO has attracted many users, including middle-aged and older people who were not previously active in games. Further, it is possible to guide users to a specific place (for example, a McDonald's store) using an event of the game by linking the game with a place in a space in which people actually live. Because this is a great advantage for those who want to guide users to a store, business models (sponsored locations) in which a company that wants to invite people to own stores become sponsors of Pokémon GO have been created.

### CITATION LIST

### Patent Literature

[PTL 1] Japanese Patent Application Publication No. 2013-025381

### Non Patent Literature

[NPL 1] Hisashi Kashima, Yukino Baba: Overview of Human Computation (<Special Issue> Human Computation and Crowdsourcing), Artificial Intelligence, Vol. 29, No. 1, 2014 [NPL 2] Haipâ Rinku Kuukan karano Netto Gêmu Kontentu Seisei Sian -SILHOUET-(Support for generation of net game content from hyperlink space-SILHOUET: SILHOUET-), 2003 MITOU software creation business

### SUMMARY OF THE INVENTION

### Technical Problem

The inventor of the present application is paying attention to the WWW as another place in which people live in real life. The WWW is used by many people via web browsers, and in particular, office workers spend much time browsing the web for the purpose of collecting information and the like. That is, it is no exaggeration to say that the WWW is a second living space for many people. When the WWW can be converted into a game, for example, it is possible to guide people to a specific website using an event of the game. Further, human computation using games can also be realized. Human computation involves solving problems difficult for a computer to solve by using human processing power, and one scheme involves converting tasks into games and encouraging people to work is used (NPL 1). For example, a game operator may be able to collect a large amount of desired information at a low cost by incorporating a task of searching for specific information that is difficult for a computer into a task in a game.

In order to realize the above, we think that the following requirements should be realized.

1. The user can play the game on a web browser that the user uses on a daily basis.
2. The user can play the game on any web page.
3. Content of the Game changes in connection with a URL or content of a group of web pages.

First of all, a game should be able to be played on a web browser that the user uses every day so that the game can be incorporated into and played as an extension of real life. Further, it is necessary for a game to be able to be played on any web page, as in Pokémon GO in which a game can be played at any location. It is thought that it is good for content of a game to change in connection with content of a group of web pages in the way that content of the game changes according to location in Pokémon GO (for example, different monsters appear depending on location, with specific monsters tending to appear in an area near the sea, or the like).

However, while a browser game played by accessing a specific web page satisfies requirement 1 above, the same game cannot be played on any web page. SILHOUET (NPL 2) creates content of a game in connection with a hyperlink structure on the web, but the Game cannot be played on a web browser that is used on a daily basis.

The invention using the add-on of the browser (PTL 1) satisfies requirements 1 and 2 above. On the other hand, for requirement 3, although game content changes in connection with an operation of a specific web page or web browser, this is only in line with an algorithm described in a program in advance, and when the type of connection is desired to be changed later, it is necessary for the add-on to be updated, which is inefficient.

The present invention has been made in view of the above points, and an object of the present invention is to make it possible to efficiently realize a game on any web page.

### Means for Solving the Problem

Therefore, in order to solve the above problems, a computer executes: a first transmission procedure for transmitting first information including information on a web page displayed on a web browser to an information processing device connected via a network; a first reception procedure for receiving second information on a screen of a game using the web page, the second information being generated on the basis of the first information by The information processing device; a display procedure for displaying the screen on the basis of the second information; and a control procedure for controlling a process according to an operation of a user with respect to the web page after the screen is displayed.

### Effects of the Invention

It is possible to efficiently realize a game on any web page.

### BRIEF DESCRIPTION OF DRAWINGS

FIG. 1 is a diagram illustrating an overview of a first embodiment.

FIG. 2 is a diagram illustrating a hardware configuration example of a user terminal 10 according to the first embodiment.

FIG. 3 is a diagram illustrating a functional configuration example of the user terminal 10 and a game server 20 in the first embodiment.

FIG. 4 is a sequence diagram illustrating as example of a processing procedure that is executed in the first embodiment.

FIG. 5 is a diagram illustrating a display example of a login screen.

FIG. 6 is a diagram illustrating a display example of a challenge window.

FIG. 7 is a diagram illustrating an example of a text monster capturing animation.

FIG. 8 is a diagram illustrating an example of a battle screen of a text monster.

FIG. 9 is a sequence diagram illustrating a processing Procedure that is added in a third embodiment.

FIG. 10 is a diagram illustrating a fourth embodiment.

### DESCRIPTION OF EMBODIMENTS

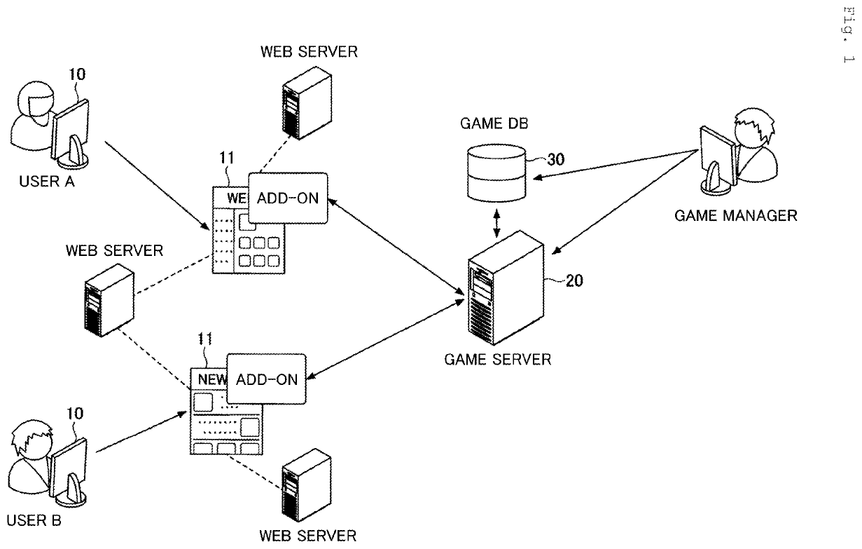

Hereinafter, a first embodiment will be described on the basis of the drawings. FIG. 1 is a diagram illustrating an overview of the first embodiment.

A person who plays a game (hereinafter referred to as a “user”) plays the game using a user terminal 10 having a web browser 11 in which an add-on (extended function for the web) is installed. When the web browser 11 reads a web page, the add-on transmits information on the web page or information on an operation of the user (web browsing history or the like) to a game server 20 together with a user ID. The game server 20 stores the received information in a game DB 30 as necessary, generates information for updating a game screen on the basis of the received information, and returns the information to the add-on. When the add-on receives the information, the add-on draws (updates) the game screen on the basis of the information.

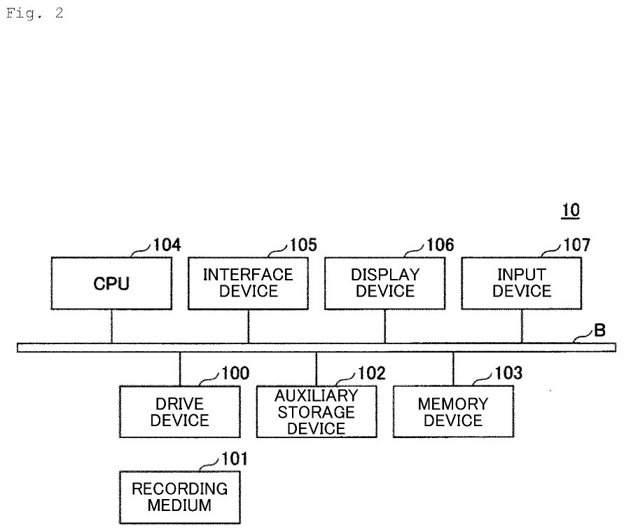

FIG. 2 is a diagram illustrating a hardware configuration example of the user terminal 10 according to the first embodiment. The user terminal 10 in FIG. 2 includes, for example, a drive device 100, an auxiliary storage device 102, a memory device 103, a CPU 104, an interface device 105, a display device 106, and an input device 107, which are connected to each other by a bus B.

A program that realizes a process in the user terminal 10 is provided on a recording medium 101 such as a CD-ROM. When the recording medium 101 storing the program is set in the drive device 100, the program is installed in the auxiliary storage device 102 from the recording medium 101 via the drive device 100. However, the program does not necessarily have to be installed from the recording medium 101, and may be downloaded from another computer via a network. The auxiliary storage device 102 stores the installed program and stores necessary files, data, and the like.

The memory device 103 reads and stores a program from the auxiliary storage device 102 when there is an instruction to start the program. The CPU 104 realizes a function related to the user terminal 10 according to the program stored in the memory device 103. The interface device 105 is used as an interface for connection to the network. The display device 106 displays a graphical user interface (GUI) based on a program or the like. The input device 107 is configured of a keyboard, a mouse, and the like, and is used for inputting various operation instructions.

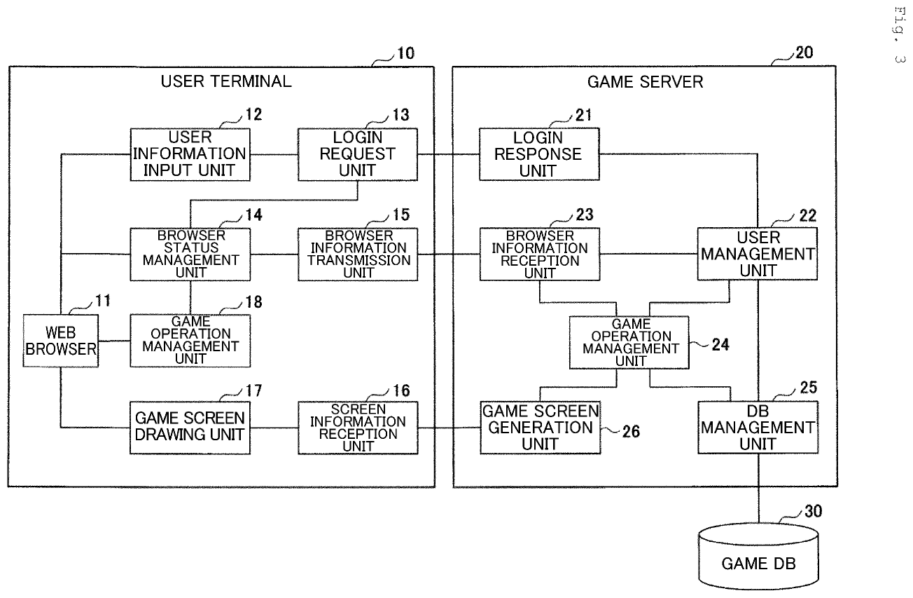

FIG. 3 is a diagram illustrating a functional configuration example of the user terminal 10 and the game server 20 in the first embodiment. In FIG. 3, the user terminal 10 includes a user information input unit 12, a login request unit 13, a browser status management unit 14, a browser information transmission unit 15, a screen information reception unit 16, a game screen drawing unit 17, a Game operation management unit 18, and the like. Each of these units is realized through a process that one or more programs (for example, add-ons) installed in the user terminal 10 causes the CPU 104 to execute.

On the other hand, the game server 20 includes a login response unit 21, a user management unit 22, a browser information reception unit 23, a game operation management unit 24, a DB management unit 25, a screen information transmission unit 26, and the like. Each of these units is realized through a process that one or more programs installed in the game server 20 cause the CPU of the game server 20 to execute. The game server 20 also uses a game DB 30. The game DB 30 can be realized by using, for example, an auxiliary storage device of the game server 20 or a storage device that can connect to the game server 20 via the network.

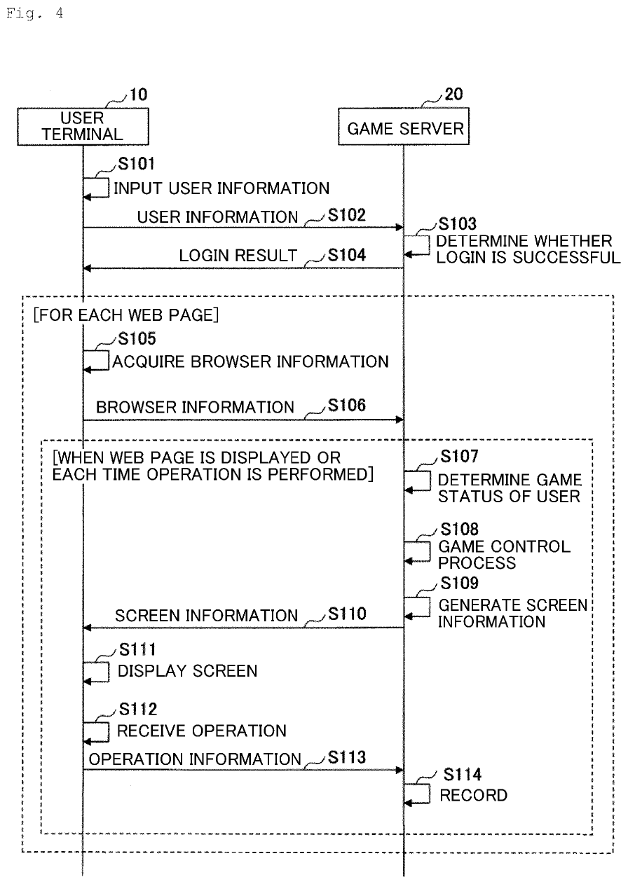

Hereinafter, a processing procedure that is executed by the user terminal 10 and the game server 20 will be described. FIG. 4 is a sequence diagram illustrating an example of the processing procedure that is executed in the first embodiment.

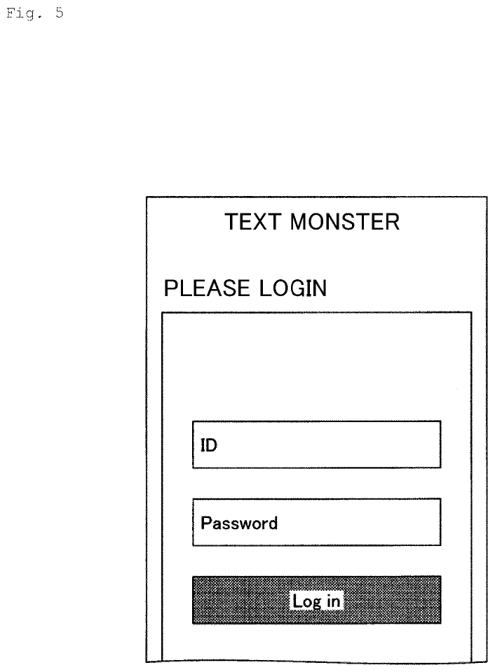

In the user terminal 10, when the add-on is activated in response to the activation of the web browser 11, the user information input unit 12 displays a login screen (FIG. 5) for an input of user information, and receives an input of user information such as a user ID and a password from the user via the login screen (S101). Subsequently, the login request unit 13 transmits the user information to the game server 20 (S102).

When the login response unit 21 of the game server 20 receives the user information, the user management unit 22 collates the user ID and password recorded in the game DB 30 with the user information to determine whether or not a login is successful (S103). When the login is successful, the user management unit 22 stores login information (the user ID or the like) in a session, and manages the user related to the user information with a logged in status for a certain period of time or until the web browser 11 is closed. Subsequently, the login response unit 21 returns a response including a login determination result to the user terminal 10 (S104).

When the login request unit 13 receives the response and the response indicates login, step S105 and subsequent steps are executed.

When any web page is displayed on the web browser 11, the browser status management unit 14 acquires information on a status of the web browser 11 (hereinafter referred to as “browser information”) from the web browser 11 (S105). The browser information includes, for example, some or all of a URL of a displayed web page, a source code of the web page, a hash value of the source code, a browsing history of the web browser 11, an ID of an active tab, and the like). Subsequently, the browser information transmission unit 15 transmits the browser information to the game server 20 (S106).

When the browser information reception unit 23 of the game server 20 receives the browser information, the game operation management unit 24 determines a status of the user in the game on the basis of the browser information, and the user information of the user related to a session in which the browser information has been received (S107). For example, the game operation management unit 24 acquires, for example, history information of the game stored in the game DB 30 in association with the user ID of the user via the DB management unit 25. The game operation management unit 24 determines the status (for example, an acquired point, etc.) of the user in the game on the basis of the history information.

Subsequently, the game operation management unit 24 executes a process necessary for control of the progress of the game (hereinafter referred to as a “game control process”) on the basis of the determination result, and outputs a processing result to the screen information transmission unit 26 (S108). The screen information transmission unit 26 generates information on a screen to be displayed on the user terminal 10 (hereinafter referred to as “screen information”) on the basis of the processing result (S109), and transmits the screen information to the user terminal 10 (S110). When the screen information reception unit 16 of the user terminal 10 receives the screen information, the game screen drawing unit 17 displays a screen regarding the game (hereinafter referred to as a “game screen”) (S111).

When an operation related to the game screen is performed on the web page by the user after the game screen is displayed, the game operation management unit 18 controls a process according to the operation (S112). Subsequently, the game operation management unit 18 transmits information on the operation (a location of a mouse pointer or the like; hereinafter referred to as “operation information”) co the game server 20 via the browser status management unit 14 and the browser information transmission unit 15 (S113). The operation information includes, for example, a part of the operation target in the web page, a character string of the operation target, and the like.

When the browser information reception unit 23 of the game server 20 receives the operation information, the game operation management unit 24 records the operation information in the Game DB 30 via the DB management unit 25 in association with the user ID (S114). After that, steps S107 and subsequent steps are repeated. In this case, when it is determined that a game status of the user has changed on the basis of the operation information (S107), new screen information (screen update information) is generated (S109), and the screen information is transmitted to the user terminal 10 (S110). As a result, the game screen is updated. The game progresses in this way.

Further, when the web page that is a display target is switched, step S105 and subsequent steps are executed again.

Next, a second embodiment will be described. Differences between the second embodiment and the first embodiment will be described. Matters not particularly mentioned in the second embodiment may be the same as those in the first embodiment.

In the second embodiment, a processing procedure will be specifically described on the basis of the following game (hereinafter referred to as “Text Monster”).

When any web page is displayed by the web browser 11 after the user successfully logs in and the game is started, a small window (a game screen) containing five English words with a challenge sentence “Find the following words!” is displayed in the upper right, upper left, or the like of the web page. The user clicks a Japanese character string corresponding to any one of the five English words on the web page with a mouse. When the clicked Japanese character string is a Japanese translation of the English word (when an answer is correct), the English word emerges as a character from the clicked Japanese character string, and the character moves in the window with a biological animation. The English word can be collected as a text monster captured by the user.

When the above game (Text Monster) is applied to the processing procedure illustrated in FIG. 4, an operation becomes as follows. Hereinafter, differences from the first embodiment will be described.

When any web page is displayed on the web browser 11 on the basis of an operation of the user after successful login, the browser status management unit 14 acquires browser information including, for example, a URL of the web page and full text (character strings) displayed on the web page from the web browser 11 (S105). The browser information transmission unit 15 transmits the browser information to the game server 20 (S106).

When the browser information reception unit 23 of the game server 20 receives the browser information, the game operation management unit 24 determines a status of the user in Text Monster (for example, the captured text monster (English word) or the like) on the basis of the browser information and the user information of the user related to the session in which the browser information is received (S107). Subsequently, the game operation management unit 24 extracts one or more character strings forming a part of the full text included in the browser information and executes translation from an original language (here, Japanese) to another language (here, English) for each character string as the game control process (S108). For example, the game operation management unit 24 performs morphological analysis on the full text, randomly selects five words (Japanese character strings) from a result of the morphological analysis, and executes translation (Japanese-English conversion).

Subsequently, the screen information transmission unit 26 generates information including five English words and five Japanese character strings in the web page corresponding to each English word as screen information (S109), and returns the screen information to the user terminal 10 (S110).

When the screen information reception unit 16 of the user terminal 10 receives the screen information, the game screen drawing unit 17 overlay-displays a screen including a challenge sentence or the like included in the screen information (hereinafter referred to as a “challenge window”) on the web page as a game screen (S111).

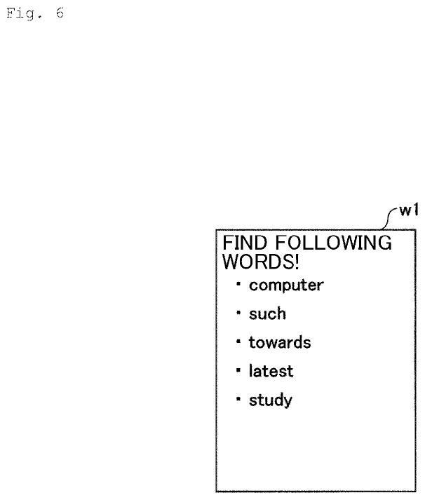

FIG. 6 is a diagram illustrating a display example of a challenge window. A challenge window w1 illustrated in FIG. 6 includes a challenge sentence “Find the following words!” and five English words such as “computer”, “such”, “toward”, “latest,” and “study” (hereinafter referred to as “target English words”).

Further, the game screen drawing unit 17 searches for a part of a Japanese character string corresponding to each target English word in the source code of the web page using a script (for example, JavaScript (registered trademark)), inserts a <span> tag into the part (the part is enclosed with a start tag <span id=“word0”> and an end tag </span> (here, “word0” is a different character string for each target English word)), and generates a listener that acquires a mouse click event with respect to the part. The script may be attached to the add-on in advance or may be transmitted from the screen information transmission unit 26 to the screen information reception unit 16 together with the screen information in step S110, for example. Further, the listener may be registered in the source code of the web page, for example. The listener functions as the game operation management unit 18.

When the user clicks a Japanese character string corresponding to any one of the target. English words on the web page (S112), the game operation management unit 18 that is a listener displays a text monster capturing animation related to the target English word (for example, an animation in which the English word moves to the challenge window w1 in a caterpillar-like action).

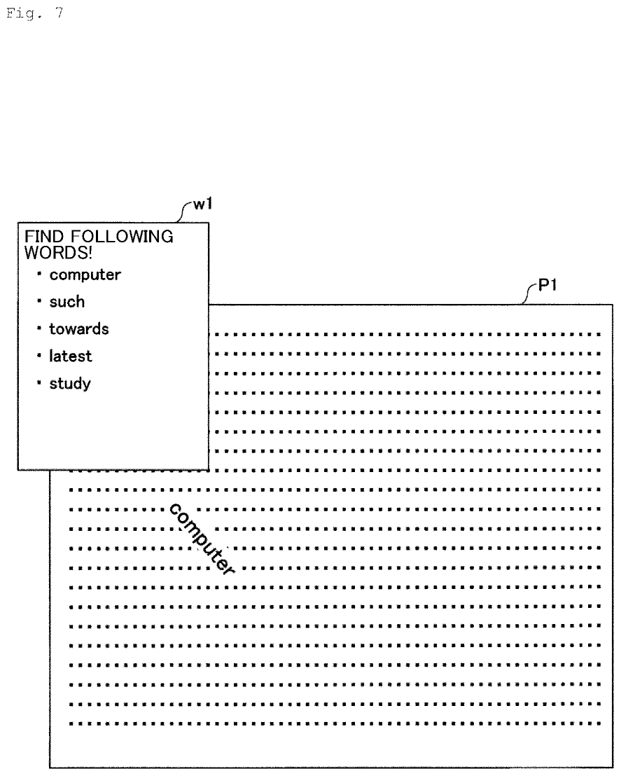

FIG. 7 is a diagram illustrating an example of a text monster capturing animation. In FIG. 7, a state in which a character string animation “computer” is displayed when the Japanese character string “ [symbol] ” corresponding to “computer” is clicked on the web page P1 is illustrated.

Subsequently, the game operation management unit 18 transmits information indicating that a correct English word corresponding to the Japanese character string selected by the user is the text monster captured by the user, as the operation information, to the game server 20 via the browser status management unit 14 and the browser information transmission unit 15 (S113).

When the browser information reception unit 23 of the game server 20 receives the operation information, the game operation management unit 24 registers the English word as a text monster captured by the user in the game DB 30 in association with the user ID of the user via the DB management unit 25 (S114).

Subsequently, step S107 and subsequent steps are executed. In this case, in step S107, it is determined that the user has captured a new text monster. In step S108, it is determined that the English word corresponding to the text monster should be removed from the challenge window w1. In step S109, screen information including four English words after that English word has been removed, and four Japanese character strings in the web page corresponding to the respective English words is generated. In step S110, the screen information is transmitted to the user terminal 10. As a result, in step S111, the English word “computer” is deleted from the challenge window w1. The game is continued in this way. For example, when the user captures the text monsters related to all the English words in the challenge window w1, the user switches the web page serving as a display target on the web browser 11 to newly set text monsters related to five English words as capturing targets. Alternatively, the user may display another web page on the web browser 11 and try to capture five English words to be selected for the web page before capturing all five English words.

It is also possible to realize navigation (inviting people to the web page) or human computation by improving the above game (Text Monster). For example, when a difficulty level of the English words (the text monsters) is higher, the text monsters are stronger. Further, an English word displayed in a challenge is not an English word corresponding to a character string randomly selected from the Japanese words forming the web page serving as a display target, but is displayed according to a certain rule. When the game operation management unit 24 of the game server 20 is configured so that an English word with a high difficulty level is likely to appear on a specific web page (in other words, so that a difficulty level of an English word corresponding to a Japanese character string on a specific web page becomes high), many users will visit the web page in order to capture strong text monsters and the navigation will be realized.

Further, for example, one English word that is displayed as a challenge at a time is set, and a click of a Japanese character string corresponding to the English word is recorded, transmitted with an incorrect answer to the game server 20, and recorded in the game DB 30. This is nothing more than collecting data on Japanese words that humans are likely to make mistakes on with regard to English words (human computation).

Further, Text Monster described above is a single player game, but each user assigns one or more text monsters (“computer” in FIG. 7) captured by the user to any web page so that the text monsters can occupy the web page (in a pseudo manner). In this case, for example, when a list of English words (text monsters) captured by the user is displayed in the challenge window w1 or in a window different from the challenge window w1, and any one of the English words is selected from the list, a user interface enabling the selected English word to occupy the displayed web page may be provided. However, when a web page already occupied by another user is being displayed, a window indicating that the web page is occupied by the other user may be displayed so that the occupation is prevented. A URL of the web page occupied by each user is stored in, for example, the game DB 30.

When the displayed web page is already occupied by another user, the user selects one or more text monsters from among text monsters that the user has already captured, attacks the web page, fights a battle with a text monster owned by the other user, and steals the web page, thereby realizing a multiplayer game.

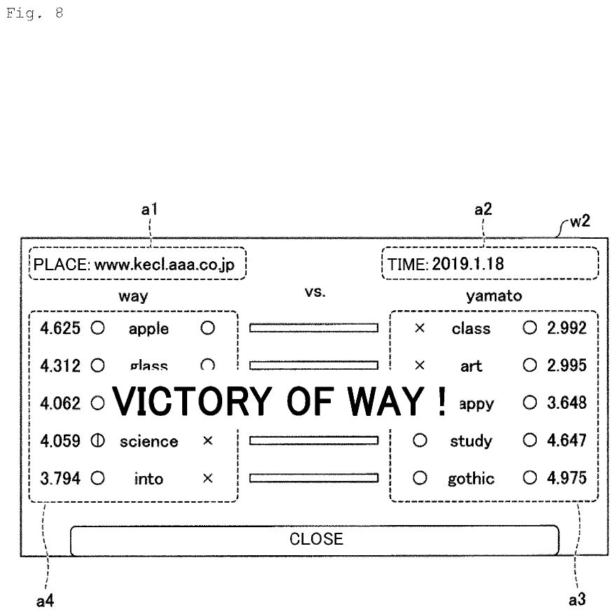

FIG. 8 is a diagram illustrating an example of a battle screen of a text monster. In a battle screen w2 illustrated in FIG. 8, an area a1 indicates a URL of a web page (hereinafter referred to as a “target page”) displayed by a user way. An area a2 indicates a current date. An area a3 indicates a list of text monsters (English words) that a user yamato, who has already occupied the target page, has selected to defend the target page. An area a4 indicates a list of text monsters (English words) that the user way has selected to attack the target page. In the area a3 and the area a4, a numerical value displayed next to each text monster (English word) is, for example, a value indicating the strength (combat capability) of each text monster based on a difficulty level of each English word.

The game screen drawing unit 17 displays the battle screen w2 on the basis of the screen information transmitted from the game server 20 in response to an instruction of the user way to start a battle on the game screen displayed before the bathe screen w2 is displayed, for example. A result of the battle may be calculated on the basis of a strength of the text monster selected by each user.

Thus, the client (the user terminal 10) is of a server-client type having an add-on such that game data of each user (for example, data of a captured text monster or an occupied web page of each user) can be managed on the game server 20, thereby realizing such a multiplayer game.

Next, a third embodiment will be described.

Differences between the third embodiment and the second embodiment will be described. Matters not particularly mentioned in the third embodiment may be the same as those in the second embodiment.

In a game such as that according to the second embodiment, the full text of the web page displayed on the user terminal 10 needs to be transmitted to the game server 20. However, when the user is browsing a web page that is not open to the public, transmission of the full text of the web page to the game server 20 may be a problem. For example, when full text of a specific web page of a website on an intranet in a company is transmitted to a game server 20 installed outside the company, confidential information is likely to be leaked. Examples of web pages that are not open to the public may include such a web page on an intranet, and a web page that is limited to members (a web page that can be viewed by only specific members).

Therefore, in the third embodiment, a method of determining whether or not a character string or the like on a web page browsed by the user may be automatically transmitted to the game server 20 is disclosed.

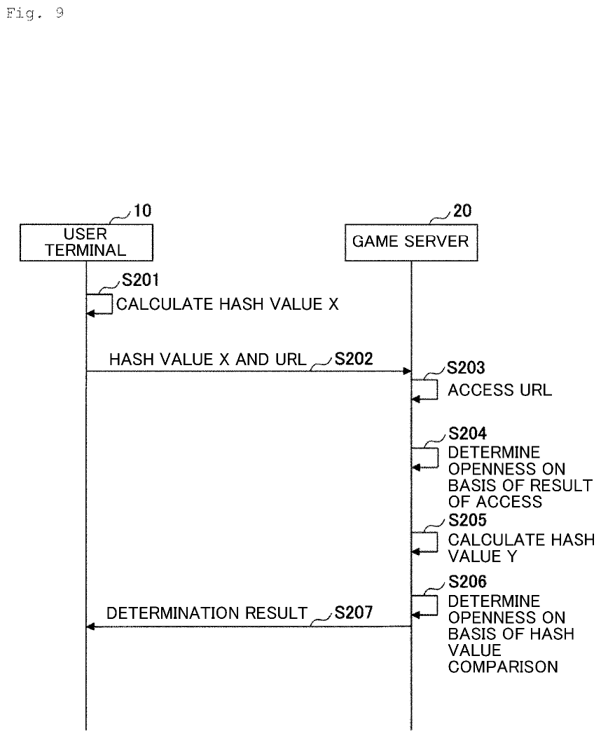

FIG. 9 is a sequence diagram illustrating a processing procedure that is added in the third embodiment. In the third embodiment, when any web page is loaded into the web browser 11 in a state in which the game is activated by the add-on, the processing procedure illustrated in FIG. 9 is executed each time before step S105 and subsequent steps are executed (before the browser information of the web page is transmitted).

The browser status management unit 14 calculates a hash value (hereinafter referred to as “hash value X”) of the source code (HTML) of the web page displayed by the web browser 11 (hereinafter referred to as “target page”) (S201). Subsequently, the browser information transmission unit 15 transmits the hash value X and the URL of the target page to the game server 20 (S202).

When the browser information reception unit 23 of the game server 20 receives the hash value X and the URL, the game operation management unit 24 attempts to access the URL (acquire a source code of the target page from the URL) (S203). Subsequently, the game operation management unit 24 determines whether or not the target page is open to the public on the basis of a result of the access (hereinafter referred to as “openness”) (S204). Specifically, when the access fails due to a 404 error or the like (when the source code of the web page cannot be acquired), the game operation management unit 24 determines that the target page is not open to the public.

When it is determined in step S204 that the target page is not open to the public, step S205 and subsequent steps are not executed and a response indicating that the game cannot be executed with respect to the target page is returned from the browser information reception unit 23 to the user terminal 10. When the browser information transmission unit 15 receives the response, step S105 and subsequent steps in FIG. 4 are not executed.

On the other hand, when the web page can be acquired, the game operation management unit 24 calculates the hash value of the source code of the web page (hereinafter referred to as “hash value Y”) using the same algorithm as that for the browser status management unit 14 of the user terminal 10 (S205). Subsequently, the game operation management unit 24 determines the openness of the target page on the basis of a comparison between the hash value X and the hash value Y (S206). Specifically, the game operation management unit 24 determines that the target page is open to the public when the hash value X and the hash value Y match, and otherwise determines that the target page is not open to the public.

Step S206 is based on the premise that a web page open to the public is displayed in the same way to all viewers. That is, when a URL of a web page that is not open to The public is accessed, the access itself is successful, but a web page included in the response is likely to differ between a user who can access the web page and a user who cannot access the web page. For example, a response including a web page showing prohibition of the access is likely to be returned to the user who cannot access the web page. Therefore, in the present embodiment, even when the access is successful, the openness of the target page is determined on the basis of the identity, of the acquired web page.

However, display content of recent web pages may differ depending on a type of web browser, a display timing, or the like. For example, in a web page in which an advertisement is embedded, a link to a different advertisement is embedded in the source code each time the web page is displayed. Therefore, in the above method, even when the web page in which the advertisement is embedded is open to the public, the web page is likely to be determined not to be open to the public due to mismatch of hash values.

Therefore, as a hash function used for calculation of the hash value, a locality sensitive hashing (LSH) may be used instead of a widely used hash function such as MD5 or SHA. LSH is a hash algorithm having a property that hash values of content having a high degree of similarity are similar to each other. When LSH is used, the game operation management unit 24 may compare the hash value X with the hash value Y, determine that the target page is open to the public when the degree of similarity is equal to or higher than a threshold value, and determine that the target page is not open to the public when the degree of similarity is smaller than the threshold value.

The inventor of the present application performed a confirmation using minhash that is a kind of LSH, in which a determination was performed with a degree of similarity of about 90% set as a threshold value such that a web page in which an advertisement is embedded but that is open to the public can be recognized as a web page open to the public, and the web page open to the public and the web page not open to the public can be fairly correctly separated.

Subsequently, a response including a result of the determination in step S206 is returned from the browser information reception unit 23 to the user terminal 10 (S207). When the browser information transmission unit 15 of the user terminal 10 receives the response, the browser status management unit 14 determines whether or not step S105 and subsequent steps can be executed on the basis of the determination result. That is, when the determination result indicates that the target page is open to the public, the status management unit determines that step S105 and subsequent steps can be executed. In this case, step S105 and subsequent steps are executed. On the other hand, when the determination result indicates that the target page is not open to the public, the status management unit determines that step S105 and subsequent steps cannot be executed. In this case, step S105 and subsequent steps are not executed.

As described above, according to the third embodiment, it is possible to reduce the possibility that information on the web page that is not open to the public is leaked to the outside.

Next, a fourth embodiment will be described. Difference between the fourth embodiment and each of the above embodiments will be described. Matters not particularly mentioned in the fourth embodiment may be the same as those in each of the above embodiment.

In the fourth embodiment, a method of grouping participants (competitors) of a multiplayer online game for each user browsing the same web page using the method of determining the identity of the web pages described in the third embodiment will be described.

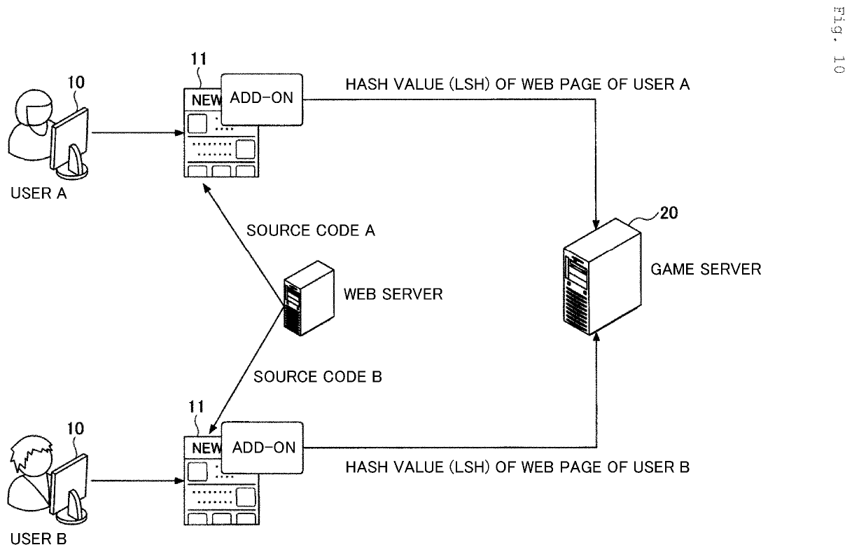

FIG. 10 is a diagram illustrating the fourth embodiment. In FIG. 10, the browser information transmission unit 15 of the user terminal 10 of each user (user A and user B) transmits the hash value (LSH) of the source code of the web page browsed by each user to the game server 20. The transmission of the hash value to the game server 20 may be performed at the same timing as in the third embodiment.

The game operation management unit 24 of the game server 20 can specify a group of users who are targets of the game on the same web page by comparing the hash values related to the respective users. For example, when a degree of similarity between a hash value (LSH) related to user A and a hash value (LSH) related to user B is equal to or greater than a threshold value, it can be determined that user A and user B have the same web pages as game, targets. The hash value related to each user may be registered in the game DB 30 in association with the user ID when the browser information reception unit 23 receives the hash value. By doing so, even when a game is not a real-time game (that is, even when a timing at which each user plays the game is asynchronous), it is possible to specify a group of users whose game targets are the same web pages.

In the case of a real-time game, the game operation management unit 24 may manage a group of currently logged-in users in a group of users whose game targets are the same web pages as participants of the game.

For a multiplayer online game, it is possible to avoid the occurrence of inconsistency due to different backgrounds of respective participant in a real-time game by grouping users whose game targets are the same web pages.

Further, even when a game is not a real-time game, consistency and fairness among participants can be guaranteed. For example, in a game such as SimCity, it is assumed that a certain user arranges a game object on a web page that is a background. When this is viewed by another user and a display of the web page is not the same, the background of the web page and a location of the game object are shifted. According to the present embodiment, it is possible to increase a possibility that such inconsistency will be resolved. Further, in the game such as SimCity, advantages and disadvantages (difference in ease of building a city) occur depending on the web page serving as the background. When competitors are limited to a group of users whose the target is the same web page as in the present embodiment, it is possible to eliminate the unfairness due to a difference in the background (web page).

Even when web pages that respective users set as a target are the same, a layout of the web page may be different among the users depending on a version of the web browser 11, scaling according to a function of the web browser 11, or the like. However, it is thought that it is important that at least the source code of the web page is the same (substantially the same except for an advertisement or the like) in order to create a game that is closely linked to web content.

Further, the web page determined to be open to the public using the method shown in the third embodiment may be set as a target of the multiplayer online game. Further, a display status (a screen layout) in the web browser 11 of the user terminal 10 of a certain user may be compared with a display status (a screen layout) in the game server 20, and the same web page may be set as the target of the multiplayer online game. This is because it is thought that the same screen layout is highly likely to be displayed among a plurality of users.

When there is only one user who is browsing the web page that is the target of the multiplayer online game, screen information of the game screen indicating waiting may be transmitted to the user terminal 10 of the user. When another user starts a game with the web page being the target, the game may be started among a plurality of users. In this case, the screen layout of the same web page in the user terminal 10 of each user may be transmitted to the game server 20, and the game operation management unit 24 may compare the layouts with each other. Only when each screen layout is the same, the start of the game may be permitted among the users.

In each of the above embodiments, it is possible to change the operation of the game to some extent without changing a program (for example, an add-on) on the user terminal 10 side by correcting a program for causing the game server 20 to function as the game operation management unit 24. For example, in the text monster, when three English words are displayed instead of five English words or French words are displayed instead of English, the game operation management unit 24 may be modified so that screen information for displaying three English words is transmitted to the user terminal 10 by the screen information transmission unit 26. This enables the user to update the game without having to install the add-ons or the like again.

As described above, according to each of the above embodiments, it is possible to efficiently realize a game on any web page.

That is, according to the present embodiment, it is possible to realize a game satisfying three requirements below by connecting the add-on of the web browser 11 and the game server 20.

1. The user can play the game on the web browser 11 that the user uses on a daily basis.
2. The user can play the game on any web page.
3. Content of the game changes in connection with a UPI or content of a group of web pages.

It is possible to expect a decrease in an updating frequency (that is, efficiency improvement) on the client side when the operation of the game is changed, by the game server 20 connected with the add-on of the web browser 11 managing the game. Further, it becomes possible to easily realize human computation or user navigation by managing the data on the game server 20 side.

Further, it is also possible to realize a multiplayer online Game on a web page through a link with the game server 20. It is possible to expect that users will be further attracted and play for a long period of time by realizing the multiplayer online game.

In each of the above embodiments, the game server 20 is an example of an information processing device. The browser information is an example of first information. The screen information is an example of second information and fourth information. The operation information is an example of third information. The hash value X is an example of a first hash value. The hash value Y is an example of a second hash value. The user terminal 10 is an example of a game realization device. The browser information transmission unit 15 is an example of a transmission unit. The screen information reception unit 16 is an example of a reception unit. The game screen drawing unit 17 is an example of a display control unit. The game operation management unit 18 is an example of a control unit.

Although the embodiments of the present invention have been described in detail above, the present invention is riot limited to such specific embodiments, and various modifications and changes can be made within the scope of the gist of the present invention described in the claims.

### Reference Signs List

10 User terminal
11 Web browser
12 User information input unit
13 Login request unit
14 Browser status management unit
15 Browser information transmission unit
16 Screen information reception unit
17 Game screen drawing unit
18 Game operation management unit
20 Genie server
21 Login response unit
22 User management unit
23 Browser information reception unit
24 Game operation management unit
25 DB management unit
26 Screen information transmission unit
30 Game DB
100 Drive device
101 Recording medium
102 Auxiliary storage device
103 Memory device
104 CPU
105 Interface device
106 Display device
107 Input device
B Bus

1. A computer-implemented method for realizing a game, comprising:
transmitting, by a first transmitter, first information including information on a web page displayed on a web browser to an information processing device connected via a network;
receiving, by a first receiver, second information on a screen of a game using the web page, the second information being generated on the basis of the first information by the information processing device;
displaying, by a displayer, the screen on the basis of the second information; and
controlling, by a controller, a process according to an operation of a user with respect to the web page after the screen is displayed.

2. The computer-implemented method according to claim 1, method further comprising:
transmitting, by a second transmitter, third information on the operation to the information processing device;
receiving, by a second receiver, fourth information on update of the screen, the fourth information being generated by the information processing device on the basis of the third information; and
updating, by an updater, the screen on the basis of the fourth information.

3. The computer-implemented method according to claim 1,
wherein:
the first information includes a character string displayed on the web page,
the second information includes one or more first character strings forming a part of the character string, and
a second character string obtained by translating each of the first character strings into another language, the screen includes a list of the second character strings, and
the controlling includes controlling the process when the first character string corresponding to any one of the second character strings included in the list is operated.

4. The game realization method according to claim 1, further comprising:
transmitting, by a third transmitter, a first hash value of a source code of the web page and a URL of the web page to the information processing device prior to the first information; and
transmitting, by the first transmitter, the first information to the information processing device according to a response transmitted from the information processing device when the information processing device is able to acquire a web page on the basis of the URL and a second hash value generated by the information processing device for the source code of the web page matches the first hash value or a degree of similarity between the first hash value and the second hash value is equal to or more than a threshold value.

5. A game realization device comprising:
a transmitter configured to transmit first information including information on a web page displayed on a web browser to an information processing device connected via a network;
a receiver configured to receive second information on a screen of a game using the web page, the second information being generated on the basis of the first information by the information processing device;
a displayer configured to display the screen on the basis of the second information; and
a controller configured to control a process according to an operation of a user with respect to the web page after the screen is displayed.

6. A computer-readable non-transitory recording medium storing computer-executable program instructions that when executed by a processor cause a computer system to:
transmit, by a first transmitter, first information including information on a web page displayed on a web browser to an information processing device connected via a network;
receive, by a first receiver, second information on a screen of a game using the web page, the second information being generated on the basis of the first information by the information processing device;
display, by a displayer, the screen on the basis of the second information; and
control, by a controller, a process according to an operation of a user with respect to the web page after the screen is displayed.

7. The computer-implemented method according to claim 2,
wherein:
the first information includes a character string displayed on the web page,
the second information includes one or more first character strings forming a part of the character string, and
a second character string obtained by translating each of the first character strings into another language, the screen includes a list of the second character strings, and
the controlling includes controlling the process when the first character string corresponding to any one of the second character strings included in the list is operated.

8. The game realization method according to claim 2, further comprising:
transmitting, by a third transmitter, a first hash value of a source code of the web page and a URL of the web page to the information processing device prior to the first information; and
transmitting, by the first transmitter, the first information to the information processing device according to a response transmitted from the information processing device when the information processing device is able to acquire a web page on the basis of the URL and a second hash value generated by the information processing device for the source code of the web page matches the first hash value or a degree of similarity between the first hash value and the second hash value is equal to or more than a threshold value.

9. The game realization method according to claim 3, further comprising:
transmitting, by a third transmitter, a first hash value of a source code of the web page and a URL of the web page to the information processing device prior to the first information; and
transmitting, by the first transmitter, the first information to the information processing device according to a response transmitted from the information processing device when the information processing device is able to acquire a web page on the basis of the URL and a second hash value generated by the information processing device for the source code of the web page matches the first hash value or a degree of similarity between the first hash value and the second hash value is equal to or more than a threshold value.

10. The game realization device according to claim 5, further comprising:
a second transmitter configured to transmit third information on the operation to the information processing device;
a second receiver configured to receive fourth information on update of the screen, the fourth information being generated by the information processing device on the basis of the third information; and
an updater configured to update the screen on the basis of the fourth information.

11. The game realization device according to claim 5,
wherein:
the first information includes a character string displayed on the web page,
the second information includes one or more first character strings forming a part of the character string, and
a second character string obtained by translating each of the first character strings into another language, the screen includes a list of the second character strings, and
the controller further configured to control the process when the first character string corresponding to any one of the second character strings included in the list is operated.

12. The game realization device according to claim 5, further comprising:
a third transmitter configured to transmit a first hash value of a source code of the web page and a URL of the web page to the information processing device prior to the first information; and
the first transmitter further configured to transmit the first information to the information processing device according to a response transmitted from the information processing device when the information processing device is able to acquire a web page on the basis of the URL and a second hash value generated by the information processing device for the source code of the web page matches the first hash value or a degree of similarity between the first hash value and the second hash value is equal to or more than a threshold value.

13. The computer-readable non-transitory recording medium of claim 6, the computer-executable instructions when executed further causing the system to:
transmit, by a second transmitter, third information on the operation to the information processing device;
receive, by a second receiver, fourth information on update of the screen, the fourth information being generated by the information processing device on the basis of the third information; and
update, by an updater, the screen on the basis of the fourth information.

14. The computer-readable non-transitory recording medium of claim 6,
wherein:
the first information includes a character string displayed on the web page,
the second information includes one or more first character strings forming a part of the character string, and
a second character string obtained by translating each of the first character strings into another language, the screen includes a list of the second character strings, and
the computer-executable instructions when executed further causing the system to:
control, by the controller, the process when the first character string corresponding to any one of the second character strings included in the list is operated.

15. The computer-readable non-transitory recording medium of claim 6, the computer-executable instructions when executed further causing the system to:
transmit, by a third transmitter, a first hash value of a source code of the web page and a URL of the web page to the information processing device prior to the first information; and
transmit, by the first transmitter, the first information to the information processing device according to a response transmitted from the information processing device when the information processing device is able to acquire a web page on the basis of the URL and a second hash value generated by the information processing device for the source code of the web page matches the first hash value or a degree of similarity between the first hash value and the second hash value is equal to or more than a threshold value.

16. The game realization device according to claim 10,
wherein:
the first information includes a character string displayed on the web page,
the second information includes one or more first character strings forming a part of the character string, and
a second character string obtained by translating each of the first character strings into another language, the screen includes a list of the second character strings, and
the device further comprising:
the controller configured to control the process when the first character string corresponding to any one of the second character strings included in the list is operated.

17. The game realization device according to claim 10, further comprising:
a third transmitter configured to transmit a first hash value of a source code of the web page and a URL of the web page to the information processing device prior to the first information; and
the first transmitter configured to transmit the first information to the information processing device according to a response transmitted from the information processing device when the information processing device is able to acquire a web page on the basis of the URL and a second hash value generated by the information processing device for the source code of the web page matches the first hash value or a degree of similarity between the first hash value and the second hash value is equal to or more than a threshold value.

18. The game realization device according to claim 11, further comprising:
a third transmitter configured to transmit a first hash value of a source code of the web page and a URL of the web page to the information processing device prior to the first information; and
the first transmitter configured to transmit the first information to the information processing device according to a response transmitted from the information processing device when the information processing device is able to acquire a web page on the basis of the URL and a second hash value generated by the information processing device for the source code of the web page matches the first hash value or a degree of similarity between the first hash value and the second hash value is equal to or more than a threshold value.

19. The computer-readable non-transitory recording medium of claim 13,
wherein:
the first information includes a character string displayed on the web page,
the second information includes one or more first character strings forming a part of the character string, and
a second character string obtained by translating each of the first character strings into another language, the screen includes a list of the second character strings, and
the computer-executable instructions when executed further causing the system to:
control, by the controller, the process when the first character string corresponding to any one of the second character strings included in the list is operated.

20. The computer-readable non-transitory recording medium of claim 13, the computer-executable instructions when executed further causing the system to:
transmit, by a third transmitter, a first hash value of a source code of the web page and a URL of the web page to the information processing device prior to the first information; and
transmit, by the first transmitter, the first information to the information processing device according to a response transmitted from the information processing device when the information processing device is able to acquire a web page on the basis of the URL and a second hash value generated by the information processing device for the source code of the web page matches the first hash value or a degree of similarity between the first hash value and the second hash value is equal to or more than a threshold value.
